(19) United States
(12) Patent Application Publication
(10) Pub. No.: US 2006/0042490 A1
(43) Pub. Date: Mar. 2, 2006

(54) Method and apparatus for de-imaging a printing forme

(75) Inventors: Stephan Fischer, Augsburg (DE); Marek Jirous, Gablingen (DE); Andreas Schiller, Mering (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/209,383

(22) Filed: Aug. 23, 2005

(30) Foreign Application Priority Data
Aug. 28, 2004 (DE) 10 2004 041 752.0

(51) Int. Cl. B41F 35/00

(52) U.S. Cl. 101/425

(57) ABSTRACT

A method for de-imaging a permanent image on a surface of a rewritable printing forme includes driving the printing forme in rotation about its longitudinal central axis during erasure. The image is ground off the surface of the rewritable printing forme by a rotating grinding device set against the surface of the printing forme being driven in rotation. Polymer removed during grinding at the surface is extracted from the surface of the printing forme.

### BACKGROUND OF THE INVENTION

The present invention relates to a method for erasing a permanent image on a surface of a rewritable printing forme, in particular within a press, the printing forme being driven in rotation about its longitudinal central axis during erasure. The present invention also relates to an apparatus for erasing a printing forme, in particular within a press.

In the art of printing with a printing forme, a distinction is drawn between methods that operate with a printing forme which can be written once and methods that operate with a rewritable printing forme. Printing methods which use rewritable printing formes may be categorized as “computer to press/direct imaging” printing methods. The present invention relates to a method and apparatus for erasing a permanent image on such a rewritable printing forme.

The applicant markets digital presses which operate with rewritable and erasable printing formes, under the product description “DICOweb”. During the production of such printing formes, a basic printing forme cylinder is preferably subjected to an erasure step or de-imaging step and a subsequent imaging step. The principles of the DICOweb technology are described in “Handbuch der Printmedien [Handbook of print media], Helmut Kipphan, pages 674 to 680, year 2000, Springer-Verlag”. An erasure apparatus which can be used when erasing a rewritable printing forme is disclosed, for example, in U.S. Pat. No. 6,694,879 (U.S. Pat. No. 6,694,879). The erasure apparatus for rewritable printing formes disclosed by U.S. Pat. No. 6,694,879 comprises a cleaning cloth. The cleaning cloth is unwound from a fresh cloth roll, pressed by a pressing element against the surface of the printing forme to be erased and the used cleaning cloth is wound up onto a dirty cloth roll. In such an apparatus, the cleaning cloth is moistened with chemicals which strip the image to be removed from the surface of the rewritable printing forme to erase a printing forme.

According to the prior art, the image on the surface of the printing forme is accordingly dissolved by a chemical solution. Following repeated erasure or deimaging of the printing forme by a chemical solution, the surface quality of the printing forme may be affected detrimentally, and may ultimately require the complete replacement of the printing forme. The erasure of rewritable printing formes with the apparatus disclosed by the prior art by using chemicals is accordingly disadvantageous overall.

### SUMMARY OF THE INVENTION

An object of the present invention is to provide a novel method and corresponding apparatus for erasing a printing forme which overcomes the problems of the prior art.

The object is met by a method for erasing a printing forme, wherein the printing forme is driven in rotation about its longitudinal central axis during erasure. According to the present invention, the image is ground off the surface of the rewritable printing forme. For this purpose a rotating grinding device is preferably set against the surface of the printing forme, which is also driven in rotation. The polymer removed during grinding at the surface is extracted from the surface of the printing forme. In this way, the surface of the printing forme is ground to reproducible and uniform roughness.

According to the present invention, a permanent image on the surface of a rewritable printing forme is erased by grinding. Grinding is a mechanical erasure operation which, as distinct from the chemical erasure operation disclosed by the prior art, has no detrimental effect on the surface condition of the printing forme. A further advantage of such mechanical erasure of the printing forme is that a more resistant polymer may be used on the printing forme for the imaging operation, which would not be capable of being stripped by a chemical solution. This has advantages for the entire printing process. In particular the edition resistance is then higher.

According to an embodiment of the present invention, a fluid, preferably distilled water, is applied to the surface of the rewritable printing forme for the purpose of grinding. The distilled water may include additives. Polymer removed during grinding at the surface of the rewritable printing forme is extracted from the surface together with the fluid and the printing forme material possibly caused by the grinding.

The apparatus according to the present invention for erasing a printing forme includes a grinding device for grinding the image off the surface of the rewritable printing forme.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a side view of an apparatus according to the present invention for erasing a printing forme; and

FIG. 2 is a sectional plan view of the apparatus according to the invention for erasing a printing forme along the line II-II in FIG. 1.

### DETAILED DESCRIPTION OF THE PRESENTLY PREFERRED EMBODIMENTS

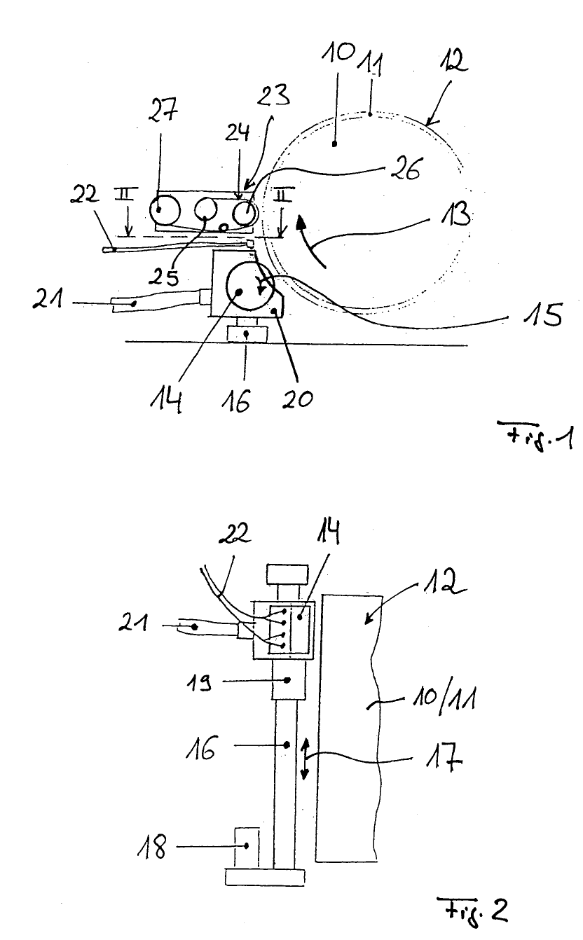

FIG. 1 is a schematic depiction of a printing forme 11 positioned on a press cylinder 10 and which is imaged with a permanent image on its surface 12. The printing forme 11 is a forme sleeve that is designed to be erasable and rewritable. An example of such a printing forme is used in digital presses marketed by the applicant under the product designation “DICOweb”.

The present invention now relates to a method and apparatus for erasing such erasable and rewritable printing formes in the region of their surface and accordingly to prepare them for a new imaging operation. The de-imaging operation is performed within the press in the present embodiment but may also be performed outside the press.

According to the present invention, a permanent image arranged on the surface 12 of the printing forme 11 is erased by being ground off the surface 12 of the printing forme 11. For the purpose of grinding, the printing forme 11 is driven in rotation about the longitudinal central axis of the printing forme 11, the direction of rotation of the printing forme 11 in FIG. 1 is indicated by arrow 13. To grind the permanent image off the surface 12 of the printing forme 11, a rotating grinding device 14 is set against the surface 12 of the printing forme 11 and driven in rotation. The grinding device 14 is in this case preferably constructed as a motor-driven grinding roller, which removes the permanent image on the surface 12 of the printing forme 11 mechanically. As can be gathered from FIG. 1, the grinding device 14 rotates in a direction opposite that of the printing forme 11, the direction of rotation of the grinding device 14 being indicated in FIG. 1 by the arrow 15 (the direction of rotation of the grinding device 14 can alternatively be in the same direction as that of the printing forme).

In the embodiment shown in FIGS. 1 and 2, the rotating grinding device 14 is moved during grinding relative to the fixed but likewise rotating printing forme 11 so that the grinding device traverses the axial width of the surface 12 of the printing forme 11 to be erased or to be de-imaged. The grinding device 14 accordingly has an axial width or extent which is less than the axial width of the surface 12 of the printing forme 11 to be erased or to be de-imaged. This movement is shown in particular in FIG. 2. As shown in FIG. 2, the grinding device 14 is mounted on a crossmember 16, the grinding device 14 being moved in the sense of the double arrow 17 relative to the fixed but rotating printing forme 11. To effect the relative movement of the rotating grinding device 14 on the crossmember 16 relative to the printing forme 11, the crossmember 16 is assigned a drive 18. The rotational movement of the grinding device 14 traversing on the crossmember 16 is provided by a further drive 19 which, together with the grinding device 14, may be moved along the crossmember 16.

The polymer material of the image to be erased, removed from the surface 12 of the printing forme 11 with the aid of the grinding device 14, is extracted from the surface 12 of the printing forme 11 by the present invention. For this purpose, the grinding device 14 is positioned in an extraction chamber 20 from which ultimately the ground-off polymer material from the image to be erased is extracted via a suction pipe 21. This ensures that the polymer material removed from the surface 12 of the image to be erased is removed from the region of the printing forme 11 and the grinding device 14.

According to the present invention, fluid such as, for example, distilled water may be applied to the surface 12 of the printing forme 11 to assist the grinding of the image to be erased from the surface 12 of the printing forme 11. The fluid may include additives. Thus, FIGS. 1 and 2 show a supply device 22, with the aid of which distilled water can be brought into the region of the grinding point between grinding device 14 and the surface 12 of the printing forme 11 to be erased. As already mentioned, the effectiveness of the grinding may be improved by supplying distilled water. Since chemicals are not used to erase the printing forme 11, the surface condition of the printing forme 11 to be erased is not detrimentally affected.

According to a further embodiment, a de-imaging unit 23 may be used in addition to the grinding device 14. The de-imaging unit 23 may be constructed, for example, as described in U.S. Pat. No. 6,694,879. The de-imaging unit 23 comprises a cleaning cloth 24, which can be unwound from a fresh cloth roll 25, a pressing roller 26 for pressing the cleaning cloth 24 onto the surface 12 of the printing forme to be erased and a dirty cloth roll 27 onto which the used cleaning cloth 24 is wound. The de-imaging unit 23 known from the prior art may be used to apply distilled water to the surface 12 of the printing forme 11 to be erased, with the aid of the cleaning cloth 24. Furthermore, the cleaning cloth 24 may be used in conjunction with the grinding device 14 on the surface 12, to pick up and transport away ground-off material from the surface 12 of the printing forme 11 to be erased. The de-imaging unit 23 known from the prior art may accordingly be used in the sense of the present invention to facilitate the grinding operation at the surface 12 of the printing forme 11 to be erased.

It should be pointed out that the de-imaging unit 23 known from the prior art may of course also be dispensed with. The entire de-imaging operation or erasure operation can be carried out with grinding device 14 and the components 16, 18, 19, 20, 21 and 22 interacting with the grinding device 14.

As has been described with reference to FIGS. 1 and 2, according to the preferred exemplary embodiment of the present invention, the grinding device 14 is moved in a traversing manner relative to the fixed but rotating printing forme 11. However, it is alternatively possible to use a grinding device whose axial width is matched to the axial extent of the printing forme to be erased or the surface of the printing forme to be erased. In this case, the grinding device would then be constructed in a fixed manner and the printing forme and the grinding device would merely be driven in rotation.

According to the present invention, a permanent image on a surface of an erasable and rewritable printing forme may erased by grinding the image off the surface of the printing forme. To assist the grinding operation, distilled water, which may include additives, may be applied to the surface to be erased. The polymer material of the image ground off at the surface, together with the distilled water is extracted from the surface of the printing forme and, if appropriate, removed from the surface of the printing forme by a cleaning cloth. With the aid of the erasure operation according to the present invention, it is possible to dispense with the use of aggressive chemicals, which have a detrimental effect on the surface condition of the printing forme. Furthermore, for the purpose of imaging the printing forme, polymers with a higher edition resistance may be used, which cannot be erased chemically. This ultimately results in an improvement in the printing quality. In addition, mechanical grinding can be carried out with considerably higher reliability than the erasure of printing formes with the aid of chemicals, known from the prior art.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for erasing or de-imaging a permanent image on a surface of a rewritable printing forme to be erased or de-imaged, comprising the steps of:
driving the printing forme into rotation such that the printing forme rotates about a longitudinal central axis of said printing forme; and
grinding the image off the surface of the rewritable printing forme to erase the image while the printing forme is driven into rotation.

2. The method of claim 1, wherein said step of grinding includes rotating a grinding device and setting the rotating grinding device against the surface of the printing forme while the printing forme is driven into rotation.

3. The method of claim 2, wherein said step of grinding further comprises the step of moving the rotating grinding device relative to the printing forme such that the rotating grinding device traverses along an axial width of the surface of the printing forme, the printing forme being held at a fixed axial position.

4. The method of claim 2, wherein said step of grinding comprises maintaining the rotating grinding device at stationary position relative to the rotating printing forme, the rotating grinding device extending over an entire axial width of the surface of the printing forme.

5. The method of claim 1, further comprising the step of extracting, from the surface, a polymer removed from the surface during said step of grinding at the surface of the rewritable printing forme.

6. The method of claim 1, wherein said step of grinding further comprises applying a fluid to the surface of the rewritable printing forme.

7. The method of claim 6, wherein the fluid comprises distilled water.

8. The method of claim 7, wherein said distilled water includes additives.

9. The method of claim 6, further comprising the step of extracting, from the surface, a polymer removed during said step of grinding at the surface of the rewritable printing forme together with the fluid.

10. The method of claim 1, further comprising the step of setting a cleaning cloth against the surface of the printing forme during said step of grinding.

11. The method of claim 10, further comprising the steps of unwinding the cleaning cloth from a fresh cloth roll impregnated with distilled water, pressing the cleaning cloth against the surface of the printing forme and winding up the cleaning cloth onto a dirty cloth roll, so that distilled water is applied to the surface of the printing forme and ground-off polymer is picked up from the surface of the printing forme by the cleaning cloth.

12. The method of claim 1, wherein said method is performed within a press.

13. An apparatus for erasing or de-imaging a permanent image on a surface of a rewritable printing forme, comprising:
a grinding device arranged and dimensioned for grinding the image off the surface of the rewritable printing forme.

14. The apparatus of claim 13, wherein said grinding device has a smaller axial width than the surface of the printing forme, the grinding device being further arranged and dimensioned for rotating and traversing along an axial length of the surface of the rewritable printing forme, wherein the rewritable printing forme is axially fixed.

15. The apparatus of claim 13, wherein said grinding device has an axial width corresponding to an axial width of the surface of the printing forme, the grinding device rotating during grinding and being stationary relative to the rotating printing forme during grinding.

16. The apparatus of claim 13, further comprising an extraction device arranged and dimensioned for extracting, from the surface, a polymer removed by said grinding at the surface of the rewritable printing forme.

17. The apparatus of claim 13, further comprising a supply device arranged and dimensioned for applying a fluid to the surface of the rewritable printing forme to be erased or de-imaged.

18. The apparatus according to claim 13, further comprising a de-imaging unit having a cleaning cloth, which can be unwound from a fresh cloth roll, a pressing roller pressing the fresh cloth roll against the surface of the printing forme to be erased, and a dirty cloth roll on which said cleaning cloth is wound.
